(19) United States
(12) Patent Application Publication
(10) Pub. No.: US 2009/0058848 A1
(43) Pub. Date: Mar. 5, 2009

(54) Predicted geometry processing in a tile based rendering system

(76) Inventor: John Howson, Hertfordshire (GB)

Correspondence Address: FLYNN THIEL BOUTELL & TANIS, P.C., 2026 RAMBLING ROAD, KALAMAZOO, MI, 49008-1631, US

(21) Appl. No.: 12/069,366

(22) Filed: Feb. 8, 2008

(30) Foreign Application Priority Data
Aug. 30, 2007 (GB) 0716890.9

(51) Int. Cl. G06F 17/00

(52) U.S. Cl. 345/418

(57) ABSTRACT

A method and apparatus are provided to enable tile based rendering systems to operate with predicated geometry whilst only making a single rasterisation pass. To do this, geometry that is to be predicated is substituted in image data with visibility test objects and associated conditional break points. In rasterisation, when a visibility test object is encountered, a visible pixel count register is updated. On completion of rasterisation of a tile, the associated conditional break points are used to test the visible pixel count register to determine if the predicated geometry should be processed and inserted into tile object lists. If it is, then a tile object list corresponding to the predicated geometry is inserted into the tile object list for the current tile and is rasterised before moving onto the next tile.

This invention relates to a three-dimensional computer graphics rendering system in particular to methods and apparatus associated with processing predicated geometry within a tile based rendering system.

### BACKGROUND TO THE INVENTION

Predicated geometry processing is a method for reducing the overall amount of geometry processing within a graphics system by conditionally processing groups of geometry based on the visibility of a bounding volume encompassing the group of objects. This is shown schematically in FIG. 1 where a group of objects 100 is encompassed fully within a bounding cube 110.

Data representing the bounding cube is transformed into screen space at 120 and then rasterised at 130. Visibility of the objects within the bounding box is determined by incrementing a visible pixel count register 140 for every pixel within the screen space bounding cube that passes a depth test during rasterisation. If, after all pixels within the bounding cube have been processed, the pixel count register is zero then this indicates that the object(s) in the bounding volume does not contribute to the final rendered surface and the geometry processing for it can be skipped.

Tile based rendering systems are well-known. These subdivide an image into a plurality of rectangular blocks or tiles. The way in which this is done and the subsequent texturing and the shading performed is shown schematically in FIG. 2.

Firstly, a primitive/command fetch unit 201 retrieves command and primitive data from a memory and passes this to a geometry processing unit 202. This transforms the primitive and command data into screen space using well-known methods.

This data is then supplied to a tiling unit 203 which inserts object data from the screen space geometry into object lists for each of a set of defined rectangular regions or tiles. An object list for each tile contains primitives that exist wholly or partially in that tile. The list exists for every tile on the screen, although some object lists may have no data in them. These object lists are fetched by a tile parameter fetch unit 205 which supplies them tile by tile to a hidden surface removal unit (HSR) 206 which removes surfaces which will not contribute to the final scene (usually because they are obscured by another surface). The HSR unit processes each primitive in the tile and passes only data for visible pixels to a texturing and shading unit 208 (TSU).

The TSU 208 takes the data from the HSR 206 and uses it to fetch textures and to apply shading to each pixel within a visible object using well-known techniques. The TSU 208 then supplies the textured and shaded data to an alpha test/fogging/alpha blending unit 210. This is able to apply degrees of transparency/opacity to the surfaces again using well-known techniques. Alpha blending is performed using an on chip tile buffer 212 thereby eliminating the requirement to use external memory.

Once the rendering of each tile has been completed, the pixel processing unit 214 performs any necessary backend processing such as packing and anti-alias filtering before writing the resulting data to a rendered scene buffer 216, ready for display.

Because a tile based system necessarily stores object lists containing each object which could appear in a tile, it cannot be used for predicated geometry representations without performing additional render passes through the tiling system. This can lead to inefficiencies in processing.

### SUMMARY OF THE INVENTION

Preferred embodiments of the present invention provide a method and apparatus that allow tile based rendering to operate with predicated geometry with a single rasterisation pass. This is accomplished by substituting the geometry that is to be predicated with visibility test objects and conditional breakpoints. The visibility test objects are used to update the contents of a visible pixel count register and the conditional breakpoints test the state of a visible pixel count register in order to determine if the predicated geometry should be processed and inserted into the tile lists when the pixel count register indicates that the object is visible.

### BRIEF DESCRIPTION OF THE DRAWINGS

Preferred embodiments of the invention will now be described in detail by way of example with reference to the accompanying drawings in which:

FIG. 1 illustrates the predicated rendering system discussed above;

FIG. 2 shows a schematic diagram of a known tile based rendering system as discussed above;

FIG. 3 shows the tiling phase of a tile based predicated rendering operation embodying the present invention;

FIG. 4 shows the rasterisation phase of a tile based predicated rendering operation embodying the present invention;

FIG. 5a shows a block diagram of a system implementing the first (tiling) phase of the scheme illustrated in FIG. 4; and

FIG. 5b shows a block diagram of a system implementing the second (rasterisation) phase of the scheme illustrated in FIG. 4.

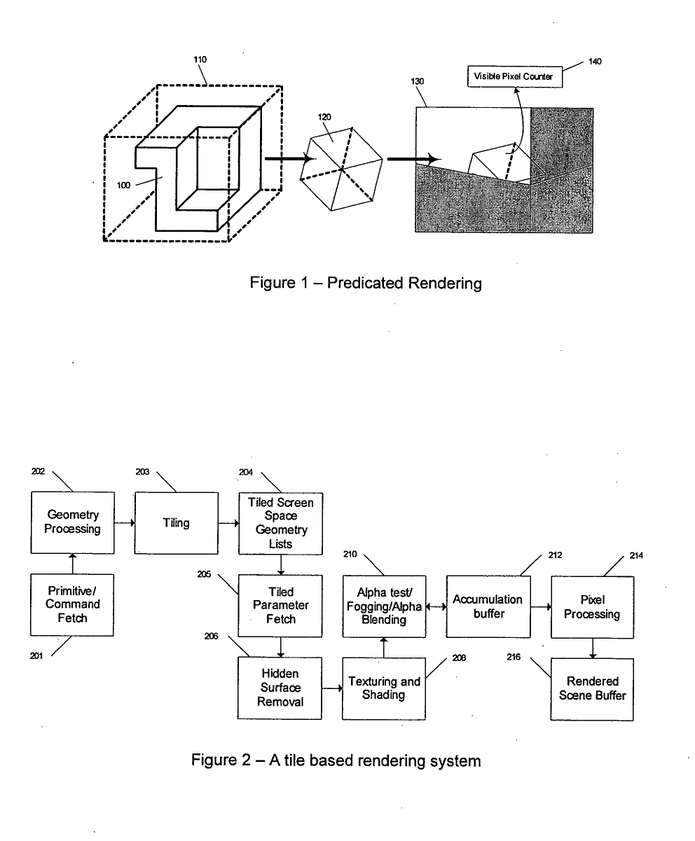

### DETAILED DESCRIPTION OF PREFERRED EMBODIMENTS

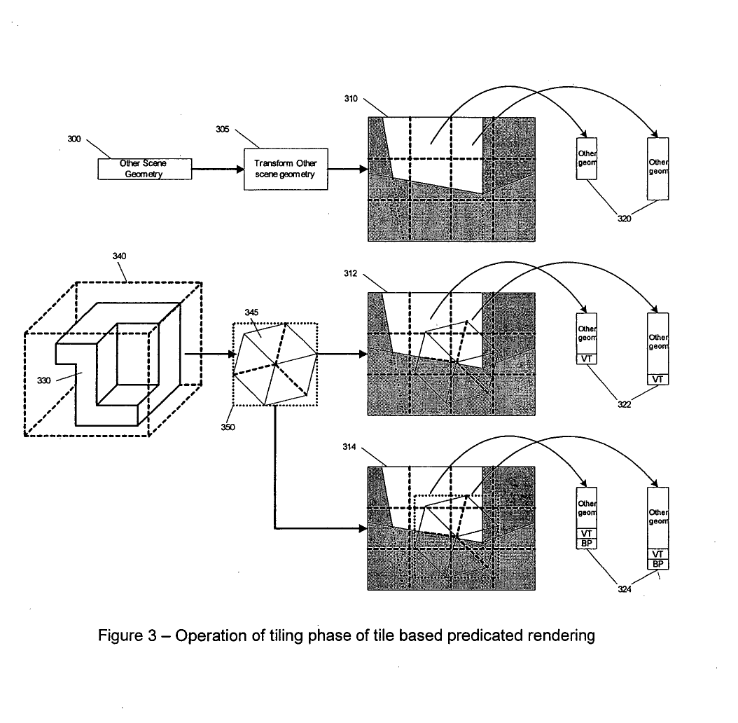

FIG. 3 illustrates the operation of the tiling phase of an embodiment of the invention. A non predicated scene geometry 300 is first processed and transformed into screen space at 305 and tiled as represented pictorially by 310. The per tile geometry lists for the second and third tiles are represented by 320 as an example.

A bounding volume 340 of geometry that is to be predicated (330) and which may form part of the scene is supplied by the system and transformed to screen space to create a visibility test (VT) object 345 which is added to the tile lists of all the tiles it intersects as represented pictorially in 311. The VT object 345 can be seen within the example per tile geometry lists illustrated for the second and third tiles at 322.

During the process of tiling the visibility test object 345, a bounding box 350 is generated that represents the two dimensional extent of the VT object 345. This bounding box is used to generate a break point (BP) object in the form of a quadrilateral object which is added to the tile lists as represented pictorially in 314 and the example per tile object lists for the second and third tiles at 324. This quadrilateral is a 2-dimensional bounding box in screen space which fully encloses the predicated scene geometry 300 after it has been transformed into screen space.

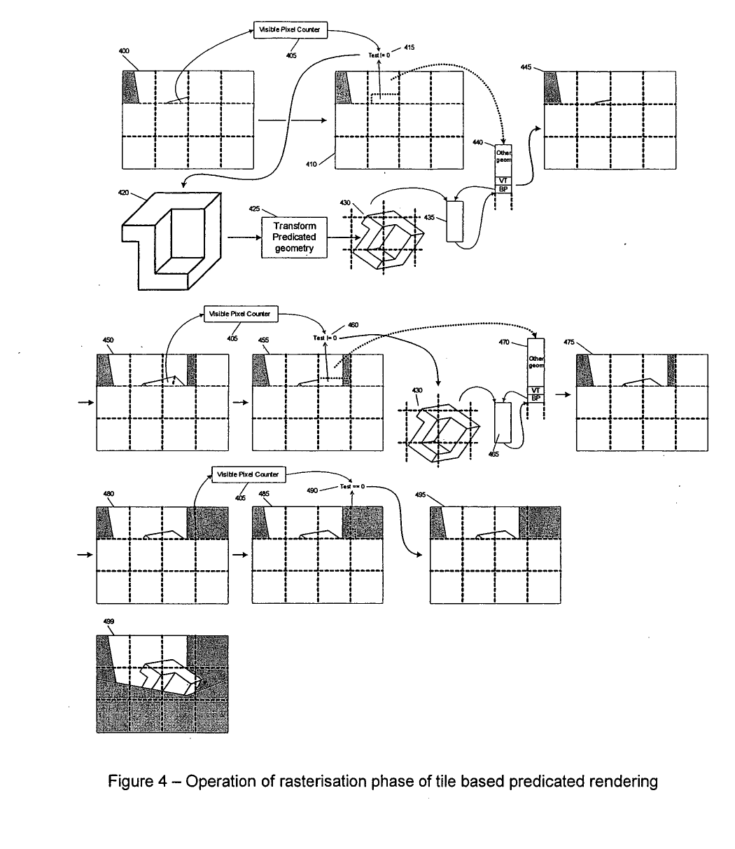

Once tiling has been completed and all the object lists compiled, excluding any predicated geometry, the scene can be rasterised as illustrated in FIG. 4. At 400 the first tile is rasterised normally, however when rasterising the visibility test object in the second tile a visible pixel counter 405 is incremented for every pixel of the VT object that lies within the second tile that is found to be visible. The 2D bounding box based break point object is then retrieved at 410. This is used to test at 415 if the visible pixel count register 405 for a pixel is non zero. As the register will be non zero as a result of the VT object causing it to be incremented the test will be passed and the BP object then halts rasterisation. The predicated geometry 420 is then transformed into screen space at 425 and tiled at 430. The generated tile object list 435 that corresponds spatially to the second tile of the image is then inserted into the second tile's object list at 440 directly after the break point object. Rasterisation is then resumed and the predicated geometry is rasterised into the second tile at 445.

Thus it can be seen that the visibility test object are rasterised like any other object except that when found to be visible (i.e. they pass depth and tensile tests used in normal rasterisation), rather than updating tag buffers to indicate the presence of the object, a visible pixel count register is incremented instead.

Break point objects are inserted separately into the object lists. This is because the visible pixel count register cannot be tested until the whole of the visibility test object overlaps the current tile has been rasterised. These break point objects themselves are not rasterised. Instead, they are used to test the state of the visible pixel count register(s) in order to determine if rasterisation should be halted to insert predicated geometry object lists into the current tile list. Thus, the break point objects only need to be tested once per tile (per break point object).

The above process is then repeated for the rasterisation of the third tile starting at 450 where the VT object again increments the visible pixel counter. It should be noted that the visible pixel counter is reset back to zero at the start of each tile. The BP object is then retrieved at 455 and the test against the visible pixel counter is performed at 460 with rasterisation being halted in dependent on the test result. As the predicated geometry has previously been transformed and tiled this process does not need to be carried out again. Instead the only the tile list 465 needs to be inserted the third tile's geometry list 470 as described previously with reference to the second tile. Rasterisation then proceeds to 475 where the inserted predicated geometry is rasterised.

Rasterisation of the fourth tile proceeds as above at 480 but as the VT object does not overlap with the fourth tile the visible pixel counter register is not incremented. When the BP object is retreived at 485 the test with the visible pixel counter at 490 yields a zero result so rasterisation continues as normal at 495 without insertion of the predicated geometry.

The above processes are repeated for the rasterisation of the remaining tiles as necessary producing the final image shown at 499.

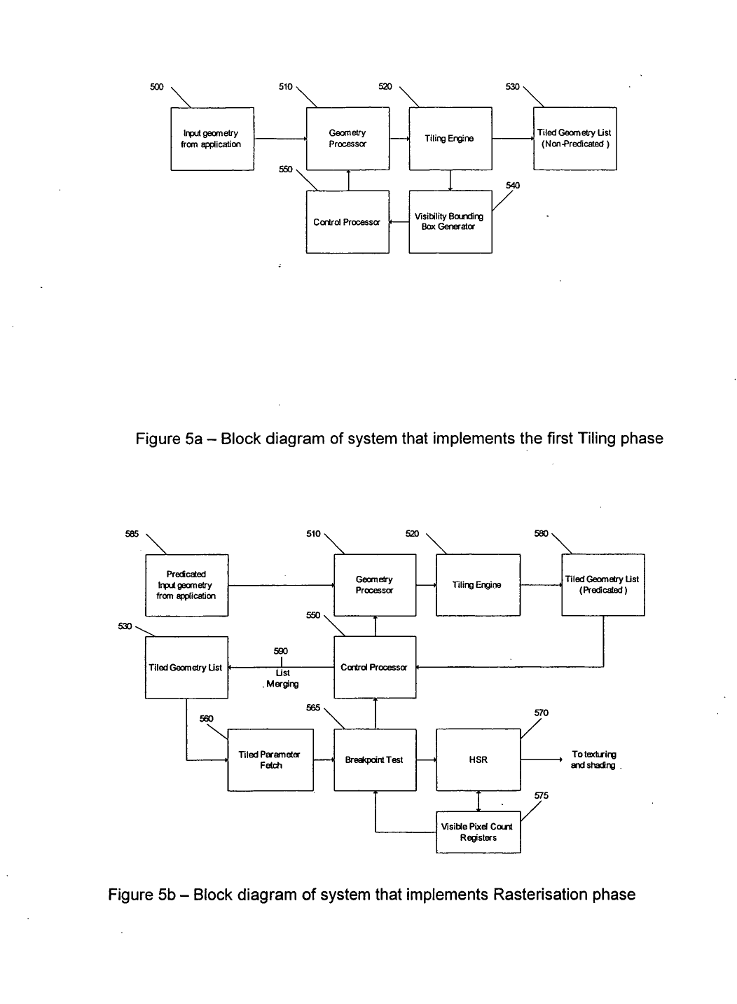

FIG. 5a illustrates a system which implements the tiling phase shown by FIG. 3. The input geometry 500 supplied by an application, which includes the visibility test objects, is submitted to a geometry processor 510 to be transformed into screen space in a well known manner. The resulting screen space geometry is then passed to a tiling engine 520 which generates tile geometry lists 530 for use during the rasterisation phase. When tiling the visibility test objects within the input geometry a Visibility Bounding Box Generator 540 tracks which tiles are overlapped by a VT object and supplies a two dimensional bounding box to a control processor 550. The control processor then takes the supplied bounding box and constructs geometry in the form of a quadrilateral that represents the required break point object and issues it through the geometry processor. This passes it to the tiling processor to add to the tiled geometry lists. These breakpoint objects include information indicating any condition or conditions, which should be met for the break point to be triggered. This process is repeated for all visibility test object within a scene.

FIG. 5b illustrates a system that implements the rasterisation phase shown in FIG. 4. It should be noted that the geometry processor 510, tiling engine 520 and the control processor 550 are the same units as shown in FIG. 5a. During the rasterisation phase a Tiled Parameter Fetch unit 560 reads in the per tile geometry lists 530 that were generated during the tiling phase (described with reference to FIG. 5a) and passes them into a Break Point (BP) test unit 565. The BP test unit checks to see if the geometry is flagged as being a break point, if not the geometry is passed to an HSR unit 570 where it is processed as previously described for a tile based rendering device.

It should be noted that visibility test objects are also passed through to the HSR unit where they increment the visible pixel count register 575 as previously described. If an object is marked as being a break point object the BP test unit tests the condition or conditions specified within the object, for example test of the visible pixel count register 575 for a non zero visible pixel count. If the test condition fails rasterisation is allowed to continue. If the test condition passes the BP test unit halts rasterisation and signals the control processor 550 that rasterisation is to be halted. If this is the first time the control processor has been signalled to for this break point object it triggers the geometry processor 510 to process the predicated geometry 585 associated with it causing the tiling engine 520 to generate a new set of tile geometry lists 580 for the predicated geometry.

The control processor will then link the predicated geometry list for the current tile with the previously generated tile object list (for non predicated geometry) 530 at 590. This process is enabled by supporting call and return operations in the tiled parameter fetch unit 560. Specifically, when generating the tile geometry lists for the predicated geometry the tiling engine terminates each tile object list with a ‘return’ command. To link the object lists together the control processor inserts a ‘call’ to the corresponding predicated tile object list into the main tile object list in place of the triggered breakpoint.

Once the predicated geometry list is patched into the current tile the control processor re-starts the rasterisation processes and the tiled parameter fetch until uses the predicated geometry object list in the tile and any contents are processed as normal.

If this is not the first time the control processor has been called for the BP object the predicated tiled geometry does not need to be generated, instead only the corresponding predicate geometry tile object list need to be patched in to the tile object list before restarting rasterisation. It should be noted that as predicated geometry is only inserted into a tile object list if the BP condition passes, no unnecessary processing work load is incurred in the HSR unit 570 or the subsequent texturing and shading unit when the predicated geometry is not visible.

The above process is repeated for all BP objects within each tile and for all tiles within a rasterised scene with texturing and shading occurring in the known manner for tiled based rendering devices.

Break point object within tile lists may be used to test for other conditions than the presence of predicated geometry. These other tests could be related to other aspects of the graphic processing, such as virtualsing the number of visible pixel count registers by inserting break point objects that cause the current state of the register to be saved/restored at points where there are no registers. Another example is the management of memory based resources in a memory control system. This would work by inserting break point objects at points in the control stream where alternative resources such as textures need to be loaded.

1. A method for processing predicated geometry within a tile based rendering system comprising the steps of:
receiving input geometry for a scene to be rendered, the input geometry including visibility test objects derived from portions of predicated geometry which may occur in the scene;
transforming the geometry including the visibility test objects into screen space;
including a visibility test object in an object list for a tile in which the visibility test object may generate image related data;
inserting a break point object into any object list which includes a visibility test object, the break point object comprising data to test conditions which should be met for a break point to be triggered.

2. A method for rasterising image data which has been tiled in accordance with the method of claim 1, the method comprising the steps of:
retrieving an object list for each tile in turn;
rasterising each pixel in a tile with the object list for that tile;
incrementing a visible pixel counter for every pixel of a visibility test object within a tile which is determined to be visible;
testing a break point object corresponding to the visibility test object to determine if any associated condition is met;
in dependence upon the result of the condition test, transforming predicated geometry associated with the visibility test object into screen space;
compiling tile object lists corresponding to the tiles of the image for the predicated geometry;
inserting a thus compiled predicated geometry tile object list corresponding to the current tile into the tile object list for the current tile; and,
resuming rasterisation for the thus modified tile object list.

3. A method according to claim 2 in which for a subsequent tile where a visibility test object is determined to be visible, a previously compiled predicated geometry object test is added to the object list for that tile.

4. A method according to claim 2 in which the step of testing whether an object is a break point object is performed prior to the rasterisation step and rasterisation is halted in dependence on the result of the testing step, whilst a predicated geometry tile object list is added to the object list for the current tile.

5. Apparatus for processing predicated geometry within a tile based rendering system comprising:
means for receiving input geometry for a scene to be rendered, the input geometry includes visibility test objects derived from portions of predicated geometry which may occur in the scene;
means for transforming the geometry, including the visibility test objects, into screen space;
means for including a visibility test object in an object list for a tile in which the visibility test object may generate image related data;
inserting a break point object into any object list which includes a visibility test object, the break point object containing data to test conditions which should be met for a break point to be triggered.

6. Apparatus for rasterising image data which has been tiled in accordance with the method of claim 1, the apparatus comprising:
means for retrieving an object list for each tile in turn;
means for rasterising each pixel in a tile with the object list for that tile;
means for incrementing a visible pixel counter for every pixel of visibility test object which is determined to be visible within a tile;
means for testing a break point object corresponding to the visibility test object to determine is any associated condition is met;
means for transforming predicted geometry associated with the visibility test object into screen space;
means for compiling tile object lists corresponding to the tiles of the image for the predicated geometry;
means for inserting a thus compiled predicated geometry tile object list corresponding to the current tile into the tile object list for the current tile; and
means for resuming rasterisation for the thus modified tile object list.

7. Apparatus according to claim 6 in which the means for compiling tile object lists corresponding to the tiles of the image for the predicated geometry performs this step the first time the means for testing a break point object determines that the associated condition is met and for the subsequent tiles in which the associated condition is met, a previously compiled predicated geometry object lists is added to the object list for that tile.

8. An apparatus according to claim in which the means for testing a break point object performs this test prior to the rasterisation means and wherein the system includes means to halt rasterisation in dependence on the result of the tests by the means for testing a break point object whilst a predicated geometry tile object list is added to the object list for the current tile.

9. A method for rasterising image data substantially as herein described.

10. An apparatus for processing predicated geometry within a tile based rendering system substantially as herein described.

11. An apparatus for rasterising image data substantially as herein described.
